(19) United States
(12) Patent Application Publication
(10) Pub. No.: US 2004/0123163 A1
(43) Pub. Date: Jun. 24, 2004

(54) Device for managing electric power source of CPU

(76) Inventor: Ta-Feng Huang, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/323,751

(22) Filed: Dec. 20, 2002

(51) Int. Cl. G06F 1/26

(52) U.S. Cl. 713/300

(57) ABSTRACT

A device for managing electric power source of CPU, which is applied to detect the consumption of power supply of Central Processing Unit (CPU) by way of an administration module. The invention, therefore, reduces the power consumption through an adjustment mechanism, as long as the power consumption of CPU exceeds a predetermined value, for the purpose of achieving the object of managing working power voltage of CPU.

### BACKGROUND OF THE INVENTION

(1) Field of the Invention

The present invention relates to a power source device, and more particularly to a device for managing power source that is applied to regulate working power voltage of Central Processing Unit (CPU).

(2) Description of the Prior Art

Science and technology of the present day has been making progress at a tremendous pace, in addition, computers have been applied to various fields, so that the functions for respective computer systems are more and more diversified. To cope with the aforementioned requirement, the computer CPU plays a unique role to a computer system.

CPU is an electric integrated circuit (IC), which carries out the functions of data processing, controlling and storing; in addition, CPU is the core of computer hardware. Various computer operations, data input and output, and hardware connection are all executed and controlled by CPU.

CPU can be distinguished by bits, e.g., 32 bits, 64 bits, etc. for instance, CPU in 8086 is with 8-bit; both 80286 and 80386 CPU's are in 16-bit; 80468 CPU is 32-bit; where CPU-type for a PC higher Pentium series is using 64-bit.

A PC with higher bit-CPU enables the arithmetic speed thereof to operate faster; however, PC-related problems, such as a great quantity of power consumption, radiation tolerance, etc., come along, the problem in interruption of PC working while the power consumption of CPU exceeds a normal power range causes the inconvenience to a user. In the light of the above situation, how to maintain speedy operation in concurrence with power source management of CPU becomes a technical topic to be solved.

### SUMMARY OF THE INVENTION

In view of the foregoing disadvantages, the present invention provides a device for managing electric power source of CPU, the main object of the invention aims at controlling required consumption of CPU working power supply for maintaining the normal operation of a computer system.

The present invention comprises an administration module and an adjustment mechanism. During the operation of a computer system, the invention detects the consumption of CPU power supply through the administration module, and reduces the power consumption thereof by way of the adjustment mechanism when the power consumption of CPU exceeds a predetermined value for achieving the object of managing CPU working power voltage.

To enable a further understanding of the objective, structural features and function of the present invention, the detailed descriptions of the preferred embodiments are followed by the brief descriptions of the drawings below.

### BRIEF DESCRIPTION OF THE DRAWINGS

FIG. 1 is a systematic diagram of a device for managing electric power source of CPU according to the present invention;

FIG. 2 is an illustrated diagram of a device for managing electric power source of CPU of the present invention;

FIG. 3 is an embodiment diagram of a detection unit of a device for managing electric power source of CPU according to the present invention; and

FIG. 4 is a hypothetical diagram showing the CPU workload with the change of time according to the present invention.

### DETAILED DESCRIPTION OF THE PREFERRED EMBODYMENTS

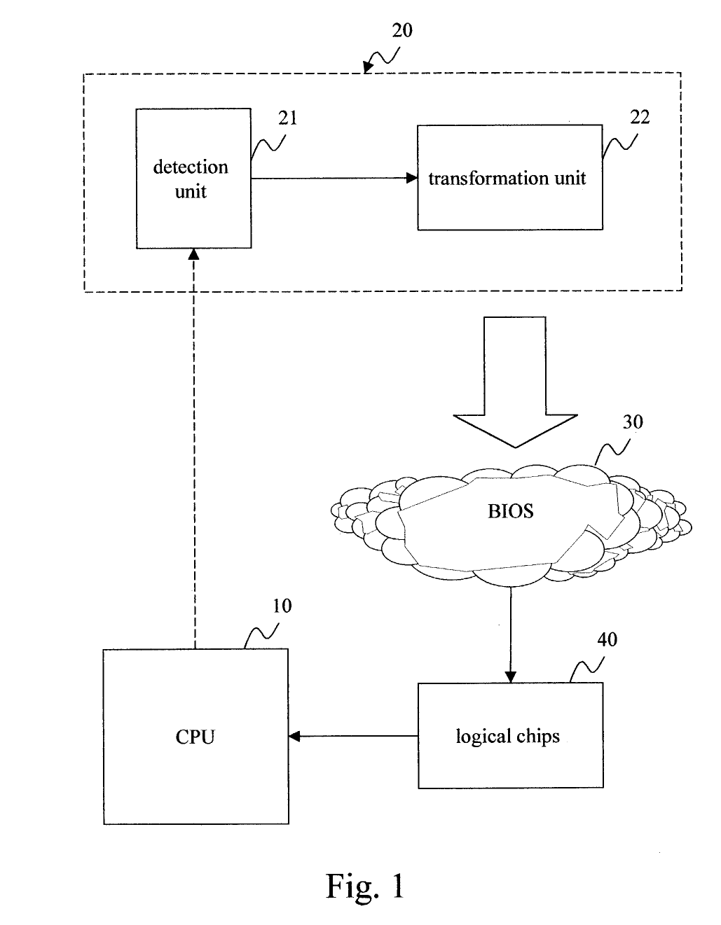

The present invention relates to a device for managing electric power source of CPU. With reference to FIG. 1, the systematic diagram of a device for managing electric power source of CPU of the invention is illustrated.

The present invention is applied to an information processing system, which can be a Notebook. The device for managing electric power source of CPU comprises: an administration module 20, an adjustment mechanism and a set of logical chips 40. The administration module 20 connects CPU 10 of an information storage system and is used to measure working power supply of the CPU 10, besides, send out a message concerning the change of the working power supply of CPU 10 to the adjustment mechanism. Subsequently, the adjustment mechanism sends out a message to the logical chips 40, while the adjustment mechanism receives the message concerning the changing working power supply of CPU 10 is on the rise. Consequently, the logical chips 40, which can be a set of South Bridge chips, decrease the working power voltage of CPU 10 to reduce the CPU 10 power supply consumption while the signal for adjustment is received.

The aforementioned administration module 20 further comprises: a detection unit 21 and a transformation unit 22; the detection unit 21 can be a composition of Switch Power ICs. The detection unit 21 is used for receiving the working power supply of CPU 10 and sending the changing working power voltage of CPU 10 to the transformation unit 22, which can be an Embedded Controller. The transformation unit 22 is utilized for transforming the changing working power voltage detected by the detection unit 21 from an analogy signal into a digital signal and sequentially sending the signal to the adjustment mechanism. The adjustment mechanism is installed in a BIOS 30.

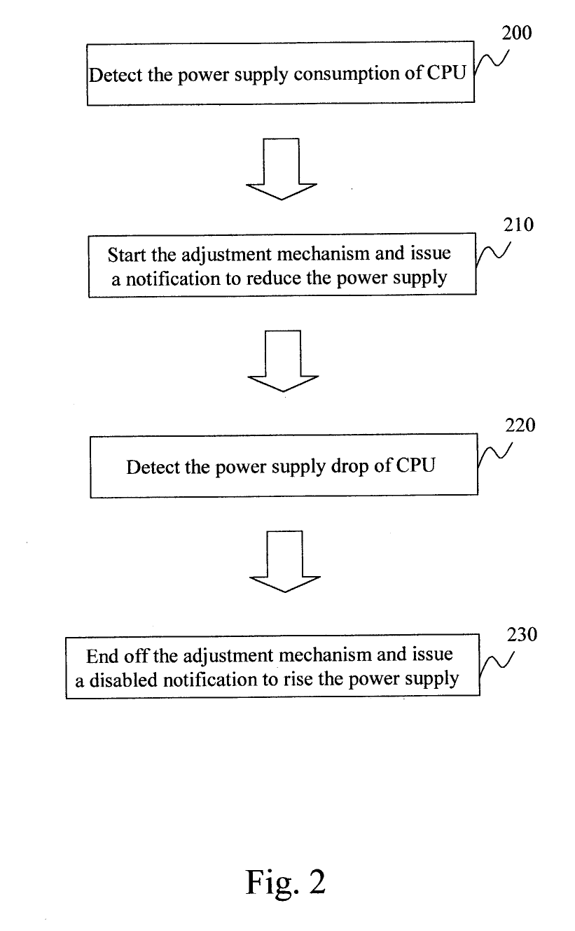

Next, the detailed flow of the method of managing CPU working power voltage of the invention is depicted as follows. FIG. 2 shows an illustrated diagram of a device for managing electric power source of CPU of the invention.

First of all, the invention sets an upper boundary value and a lower boundary value of working power voltage in the adjustment mechanism of BIOS, when the information processing system is operating, the detection unit of the administration module detects the status of the CPU power supply consumption (step 200). If working power voltage exceeds the predetermined upper boundary value thereof, the consumption of power supply is transformed by the transformation unit to enable a Structure of Management Information (SMI) to start the adjustment mechanism and issue Notifications to reduce power supply (step 210). During the process of the drop-off of power source, in the meanwhile, the detection unit detects the CPU power source drop-off status (step 220). On the contrary, when working power voltage is less than the predetermined lower boundary value thereof failing to bear the CPU workload, the adjustment mechanism then switches off and a disabled message is sent out for rising the power souse again (step 230).

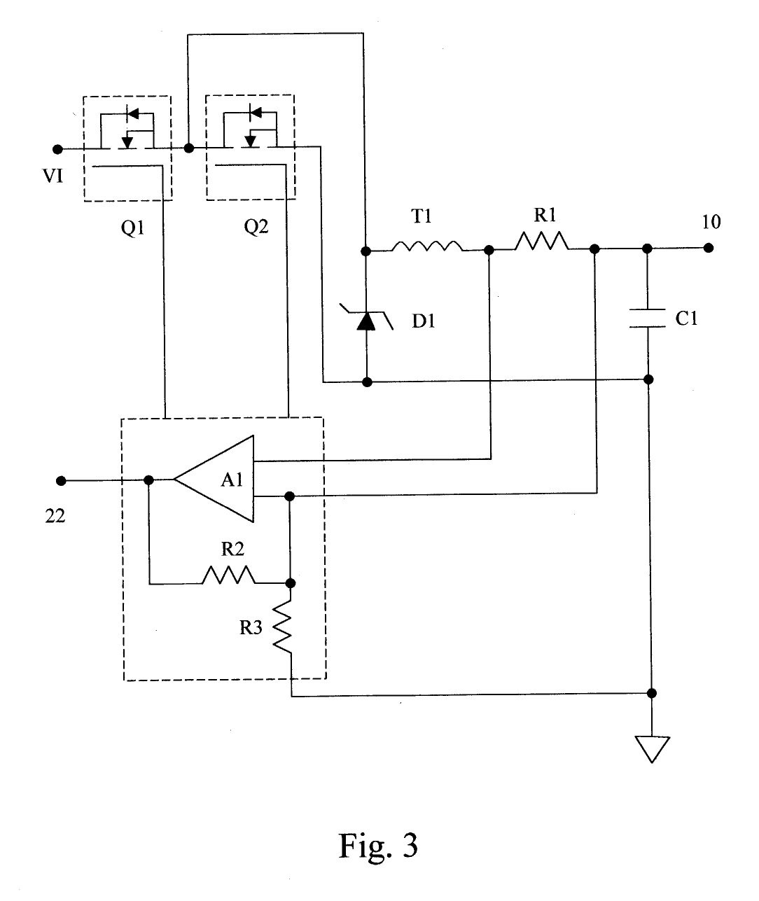

Following is the invention illustrates the circuit details of the detection unit through FIG. 3, which shows an embodiment diagram of the detection unit of a device for managing electric power source of CPU according to the invention.

After the status of power supply of CPU 10 is received, the detection unit 21 then pierces through a RC circuit that is formed by an electric capacity component C1 and an electric resistance component R1. In addition, the detection unit 21 retrieves voltage at both ends of the electric resistance component R1 for being conveyed to an arithmetic component A1 for calculation; the arithmetic component A1 can be an operational amplifier and can connect with an electric resistance component R2 and an electric resistance component R3 forming an arithmetic circuit for detecting the power supply consumption of CPU 10. The arithmetic circuit can be set in a Switch Power IC and transfers calculated value into the transformation unit 22. Moreover, an inductance component T1 is able to induce a driving voltage, which is controlled by a diode component D1 to be sent to and switch components Q1 and Q2. The switch components Q1 and Q2 are used for switching on and off the Switch Power IC according to the driving voltage; where a working voltage VI is used to provide with required working electric power for working circuits.

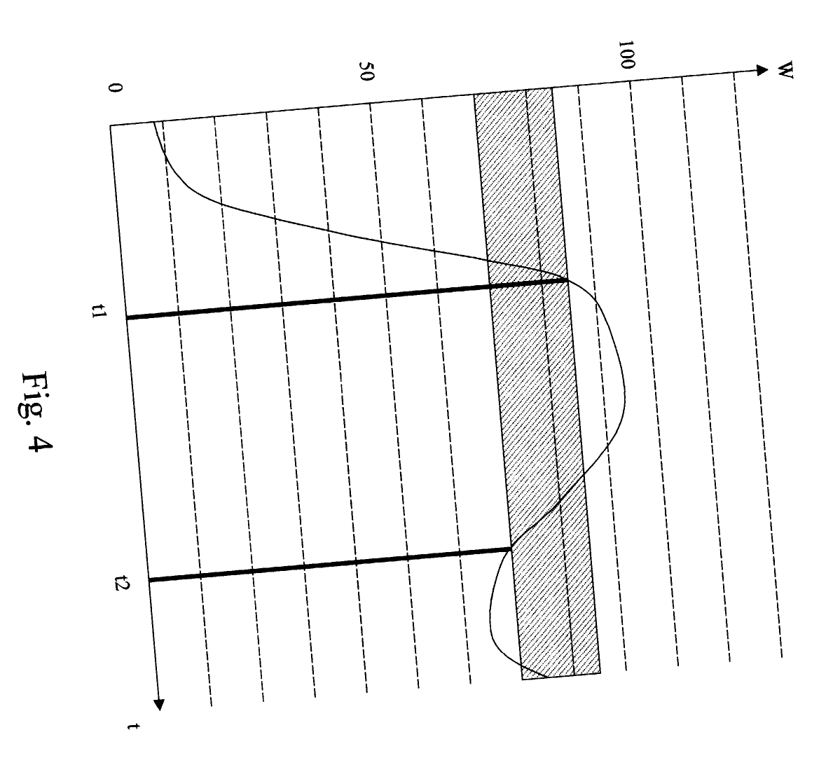

Eventually, the invention illustrates the administration efficacy of CPU referring to FIG. 4, a hypothetical diagram showing the CPU workload with the change of time.

First, the invention sets an upper boundary value and lower boundary value of working power voltage in the adjustment mechanism of BIOS, the upper boundary value is predetermined to be 85 W and the lower boundary value to be 70 W The dotted lines in the diagram show the working power voltage ranges pre-set by the inventor. When the information processing system starts, the consumption of CPU power supply goes up quickly, therefore, the device for managing power source of the invention simultaneously detects the consumption of CPU working power supply. When CPU reaches a first working time t1 and the working power voltage is over 85 W, the power source device then starts the adjustment mechanism to issue Notifications for reducing the working power voltage. The power source device also detects working power voltage of CPU. When CPU reaches a second working time t2 and the working power voltage is lower than 70 W, the power source device then issues a disabled message for stopping the pressure drop-off and smoothly rising the working power voltage. A device for managing electric power source of CPU of the invention does not cause any inconvenience of using the information processing system to a user; instead, the invention allows a user to enjoy higher CPU efficacy, moreover, enables a high-effect CPU of the information processing system to pass the safety inspection.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A device for managing electric power source of CPU is applied to an information storage system; the power source device comprising:
an administration module, connecting CPU to measure a changing working power voltage of CPU, besides, send the changing working power voltage status to an output end;
an adjustment mechanism, connecting the administration module to receive the status of changing working power voltage and issue a message for making the voltage adjustment when the working power voltage is rising; and
a set of logical chips, connecting the adjustment mechanism to receive the message for reducing working power voltage of CPU.

2. The device for managing electric power source of CPU in accordance with claim 1, wherein the adjustment mechanism further sets an upper boundary value and a lower boundary value of working power voltage. Controlling function.

3. The device for managing electric power source of CPU in accordance with claim 1, wherein the adjustment mechanism issues the message for adjusting the working power voltage, when it exceeds the upper boundary value of working power voltage.

4. The device for managing electric power source of CPU in accordance with claim 2, wherein the working power voltage causes the adjustment mechanism to stop issuing the message for adjusting voltage, when the working power voltage is lower than the lower boundary value thereof.

5. The device for managing electric power source of CPU in accordance with claim 1, wherein the administration module further comprising:
a detection unit, connecting CPU to detect the changing working power voltage of CPU; and
a transformation unit, connecting the detection unit to transforming the changing working power voltage of CPU to a digital signal.

6. The device for managing electric power source of CPU in accordance with claim 5, wherein the digital signal is sent to the adjustment mechanism by Notifications through a Structure of Management Information (SMI).

7. The device for managing electric power source of CPU in accordance with claim 1, wherein the adjustment mechanism is set in BIOS of a information processing device.

8. The device for managing electric power source of CPU in accordance with claim 5, wherein the detection unit is a Switch Power IC.

9. The device for managing electric power source of CPU in accordance with claim 5, wherein the transformation unit is an Embedded Controller.

10. The device for managing electric power source of CPU in accordance with claim 1, wherein the logical chips are a set of South Bridge chips.

11. The device for managing electric power source of CPU in accordance with claim 1, wherein the information processing system is a Notebook.
